(19) United States
(12) Patent Application Publication
(10) Pub. No.: US 2023/0077770 A1
(43) Pub. Date: Mar. 16, 2023

(54) SERVER DEVICE, SETTLEMENT RESULT NOTIFICATION SYSTEM, AND PROGRAM

(71) Applicant: TOSHIBA TEC KABUSHIKI KAISHA, Tokyo (JP)

(72) Inventor: Hirokazu TANI, Matsudo Chiba (JP)

(73) Assignee: TOSHIBA TEC KABUSHIKI KAISHA, Tokyo (JP)

(21) Appl. No.: 17/836,930

(22) Filed: Jun. 9, 2022

(30) Foreign Application Priority Data
Sep. 16, 2021 (JP) 2021-151343

(51) Int. Cl. G06Q 20/38

(52) U.S. Cl. CPC G06Q 20/389

(57) ABSTRACT

A server device includes a specifying-information acquiring unit configured to acquire transaction specifying information for specifying a transaction for which a settlement request is output from a settlement terminal, a result-information acquiring unit configured to acquire result information indicating a result of a settlement device processing, in response to the settlement request, the transaction specified by the transaction specifying information, and an output unit configured to, if a predetermined time elapses after the specifying-information acquiring unit acquires the transaction specifying information, output the result information acquired by the result-information acquiring unit to the settlement terminal that outputs the settlement request for the transaction specified by the transaction specifying information.

### CROSS-REFERENCE TO RELATED APPLICATION

This application is based upon and claims the benefit of priority from Japanese Patent Application No. 2021-151343, filed on Sep. 16, 2021, the entire contents of which are incorporated herein by reference.

### FIELD

Embodiments described herein relate generally to a server device, a settlement result notification system, and a program.

### BACKGROUND

In recent years, cashless systems have been advanced and cashless settlement such as credit card settlement, two-dimensional code settlement, or electronic money settlement has been used if a consumer purchases a commodity or a service (hereinafter collectively referred to as “commodity”). In the cashless settlement, information is transmitted and received between a settlement terminal such as a POS (Point Of Sales) terminal set in a store and a settlement server managed by a settlement company and settlement concerning a transaction is performed.

The settlement is sometimes not appropriately performed if a communication failure or the like occurs between the settlement terminal and the settlement server. For example, if the settlement terminal cannot receive a settlement completion notification indicating that the settlement is completed by processing of the settlement server, a settlement request is output again to the settlement server by operation of a store clerk or a consumer (hereinafter collectively referred to as “operator”) who operates the settlement terminal and so-called duplicate billing sometimes occurs. There has also been proposed a technique for making it possible to recognize such duplicate billing (for example, JP-A-2020-86560 (Patent Literature 1)).

However, the related art does not inform a processing result of the settlement server (“settlement completed”, “settlement impossible”, or the like) to the operator of the settlement terminal if a communication failure or the like occurs. That is, the related art recognizes the duplicate billing already caused by the operation of the operator and does not inform the processing result of the settlement server to the operator to prevent the duplicate billing from occurring.

### DESCRIPTION OF THE DRAWINGS

FIG. 1 is a diagram illustrating an overview of a settlement result notification system including a server device in at least one embodiment;

FIG. 2 is a block diagram illustrating a hardware configuration of a POS terminal in at least one embodiment embodiment;

FIG. 3 is a diagram illustrating a data configuration of a cashless settlement management file stored in a memory unit of the POS terminal;

FIG. 4 is a block diagram illustrating a functional configuration of the control unit of the POS terminal;

FIG. 5 is a block diagram illustrating a hardware configuration of a transaction management server in at least one embodiment;

FIG. 6 is a diagram illustrating a data configuration of a settlement information management file stored in a memory unit of the transaction management server;

FIG. 7 is a block diagram illustrating a functional configuration of a control unit (controller) of the transaction management server;

FIG. 8 is a block diagram illustrating a hardware configuration of a settlement result management server in at least one embodiment embodiment;

FIG. 9 is a diagram illustrating a data configuration of a settlement result management file stored in a memory unit of the settlement result management server;

FIG. 10 is a block diagram illustrating a functional configuration of a control unit of the settlement result management server;

FIG. 11 is a sequence chart illustrating a flow of the operation of the settlement result notification system;

FIG. 12 is a flowchart illustrating a flow of settlement result notification processing by the control unit of the settlement result management server;

FIG. 13 is a flowchart illustrating a flow of cashless settlement processing by the control unit of the POS terminal;

FIG. 14 is a sequence chart illustrating a flow of an operation in a modification in the settlement result notification system;

FIG. 15 is a flowchart illustrating a flow of settlement result notification result in the modification by the control unit of the settlement result management server; and

FIG. 16 is a flowchart illustrating a flow of cashless settlement processing in the modification by the control unit of the POS terminal.

### DETAILED DESCRIPTION

In general, according to at least one embodiment, a server device, a settlement result notification system, and a program that are capable of informing a settlement result of a settlement server to an operator of a settlement terminal if a communication failure or the like occurs are provided.

A server device according to at least one embodiment includes: a specifying-information acquiring unit (of at least one processor) configured to acquire transaction specifying information for specifying a transaction for which a settlement request is output from a settlement terminal; a result-information acquiring unit (of at least one processor) configured to acquire result information indicating a result of a settlement device processing, in response to the settlement request, the transaction specified by the transaction specifying information; and an output unit (output) configured to, if a predetermined time elapses after the specifying-information acquiring unit acquires the transaction specifying information, output the result information acquired by the result-information acquiring unit to the settlement terminal that outputs the settlement request for the transaction specified by the transaction specifying information.

A server device, a settlement result notification system, and a program in at least one embodiment are explained below with reference to the drawings. Embodiments are not limited by the embodiment explained below. For example, in the embodiment explained blow, a settlement terminal provided in a store is connected to a transaction management server managed by a settlement agent. However, the settlement terminal may be directly connected to a settlement server managed by a settlement company. The embodiment can also be applied to Internet shopping. In this case, an information terminal device such as a smartphone that outputs a settlement request configures a settlement terminal.

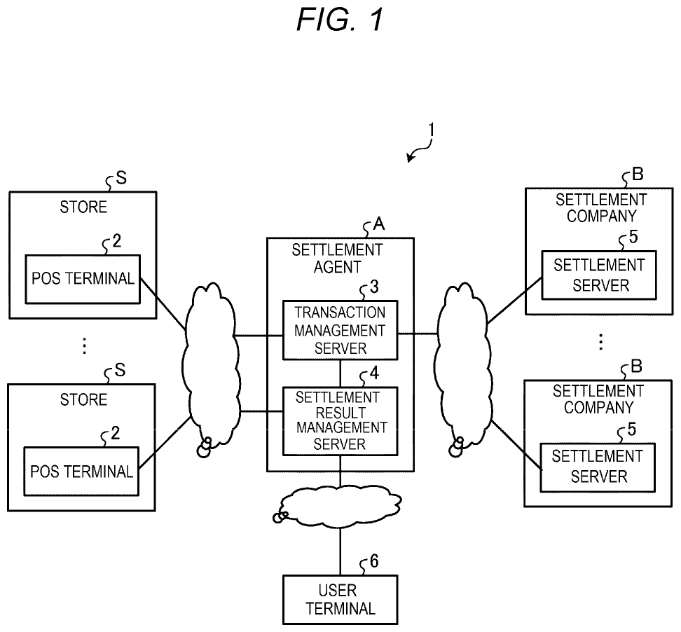

FIG. 1 is a diagram illustrating an overview of a settlement result notification system. A settlement result notification system 1 in this embodiment is constructed across a plurality of stores S that sell commodities, a settlement agent A, and a plurality of settlement companies B. The settlement agent A mediates between the stores S that desire to introduce a plurality of cashless settlement means such as credit card settlement and electronic money settlement and the settlement companies B of these settlement means.

The settlement result notification system 1 includes POS terminals 2 provided in the stores S, a transaction management server 3 and a settlement result management server 4 managed by the settlement agent A, settlement servers 5 managed by the settlement companies B, and a user terminal 6 carried by a customer who performs transactions in the stores S. The settlement result notification system 1 can also be configured by only the POS terminals 2 and the settlement result management server 4. In FIG. 1, only one POS terminal 2 provided in each of the stores S is illustrated. However, each of the stores S may include a plurality of POS terminals 2.

The POS terminals 2 and the transaction management server 3 and the settlement result management server 4 are communicably connected to each other via a network such as the Internet. The transaction management server 3 and the settlement result management server 4 are communicably connected to each other via a network such as a LAN (Local Area Network). Further, the transaction management server 3 and the settlement servers 5 are communicably connected to each other via a network such as the Internet. The settlement servers 5 may be communicably directly (not via the transaction management server 3) connected to the settlement result management server 4 via a network such as the Internet. The settlement result management server 4 is connected to the user terminal 6 via a network such as the Internet.

The POS terminal 2 is an example of a settlement terminal. The settlement result management server 4 is an example of a server device. The settlement server 5 is an example of a settlement device. The settlement result management server 4 may be managed by a company different from the settlement agent A. If the stores S directly transmit and receive information to and from the settlement companies B not via the settlement agent A, the transaction management server 3 may be absent.

In a transaction in the store S, if a consumer desires cashless settlement, a settlement request is transmitted from the POS terminal 2 to the transaction management server 3. The transaction management server 3 transmits the settlement request to the settlement server 5 of the settlement company B corresponding to the received settlement request. If settlement processing is completed in the settlement server 5, a settlement result notification is transmitted to the POS terminal 2 via the transaction management server 3. If the settlement result notification indicates that settlement is concluded, the POS terminal 2 ends checkout processing relating to the transaction by, for example, dispensing a receipt. If the settlement result notification indicates that the settlement is not concluded, the POS terminal 2 displays, for example, incompletion of the settlement.

In the flow of the cashless settlement explained above, the settlement result management server 4 manages a result of the settlement server 5 processing the transaction for which the settlement request is output from the POS terminal 2. For example, if the POS terminal 2 cannot receive the settlement result notification from the transaction management server 3 because of a deficiency of a system in the settlement agent A, a communication failure between the transaction management server 3 and the POS terminal 2, or the like, the settlement result management server 4 can provide the settlement result managed by the settlement result management server 4 to the POS terminal 2. At this time, the settlement result management server 4 can also provide the settlement result managed by the settlement management server 4 to the user terminal 6 as well.

The devices are explained in detail.

The POS terminal 2 is, for example, a self-service POS terminal with which a consumer performs commodity registration and checkout operation by himself or herself. The settlement terminal may be, for example, a normal POS terminal with which a store clerk performs commodity registration and checkout operation or a checkout device of a semi-self-service POS with which a store clerk performs commodity registration and a consumer performs checkout operation. The settlement terminal may be, for example, a terminal realized by installing a program of a checkout function in a tablet terminal or the like. The settlement terminal may be a settlement terminal exclusive for cashless settlement provided separately from a POS terminal.

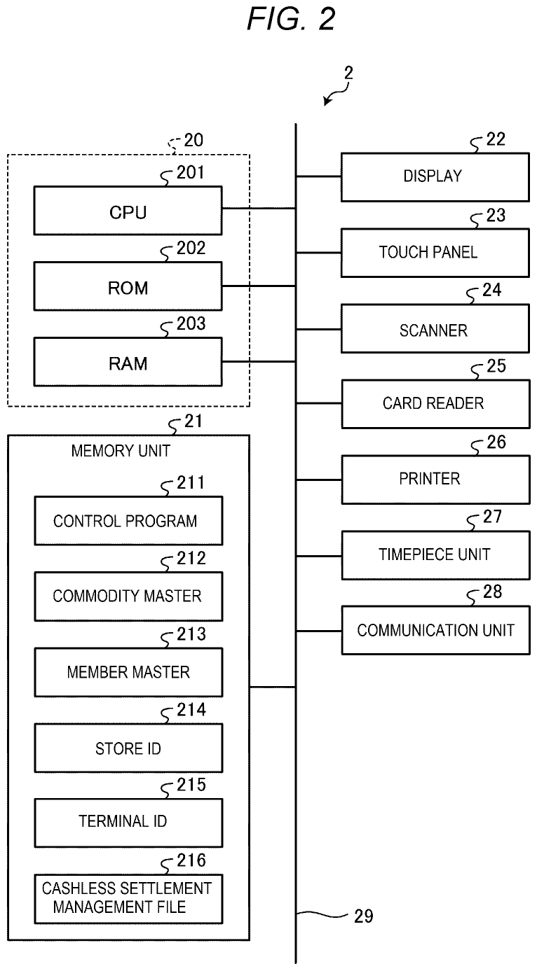

FIG. 2 is a block diagram illustrating a main hardware configuration of the POS terminal 2. The POS terminal 2 includes a control unit 20 (controller), a memory unit 21 (memory storage), a display 22, a touch panel 23, a scanner 24, a card reader 25, a printer 26, a timepiece unit 27, and a communication unit 28. The control unit 20, the memory unit 21, the display 22, the touch panel 23, the scanner 24, the card reader 25, and the printer 26, the timepiece unit 27, and the communication unit 28 are connected to one another via a bus 29 or the like.

The control unit 20 is configured by a computer including a CPU (Central Processing Unit) 201, having for example at least one processor), a ROM (Read Only Memory) 202, a RAM (Random Access Memory) 203. The CPU 201, the ROM 202, and the RAM 203 are connected to one another via the bus 29.

The CPU 201 controls the operation of the entire POS terminal 2. The ROM 202 stores various programs such as a program used for driving of the CPU 201 and various data. The RAM 203 is used as a work area of the CPU 201. Various programs and various data stored in the ROM 202 and the memory unit 21 are loaded in the RAM 203. The CPU 201 operates according to a control program stored in the ROM 202 or the memory unit 21 and loaded in the RAM 203, whereby the control unit 20 executes various kinds of control processing of the POS terminal 2.

The memory unit 21 is configured by a storage medium such as a HDD (Hard Disk Drive) or a flash memory and maintains stored content even if the POS terminal 2 is turned off. The memory unit 21 stores a control program 211, a commodity master 212, a member master 213, a store ID 214, a terminal ID 215, and a cashless settlement management file 216.

The control program 211 is, for example, a program for causing the POS terminal 2 to function as a commodity registration device, a checkout device, and a settlement terminal. That is, the control program 211 is, for example, a program for performing commodity registration based on a commodity code read by the scanner 24, a program for performing checkout processing for a transaction of a registered commodity, or a program for transmitting and receiving information to and from the settlement server 5 in order to perform cashless settlement as a part of the checkout processing.

The commodity master 212 is a master file in which commodity codes and commodity information (commodity names, prices, and the like) are associated about commodities sold in the store S. The commodity master 212 is received from a not-illustrated store server via the communication unit 28. Since the commodities sold in the store S change every day, the commodity master 212 is updated as appropriate based on information received from the store server.

The member master 213 is a master file in which member codes and member information (names, mail addresses of the user terminals 6, and the like) are associated about members of the store S. A customer registers information in the member master 213 by performing member registration.

The store ID 214 is information for identifying the store S where the POS terminal 2 is set. The store ID 214 is set if the POS terminal 2 is connected to the settlement result notification system 1.

The terminal ID 215 is information for identifying the POS terminal 2. Like the store ID, the terminal ID 215 is set if the POS terminal 2 is connected to the settlement result notification system 1.

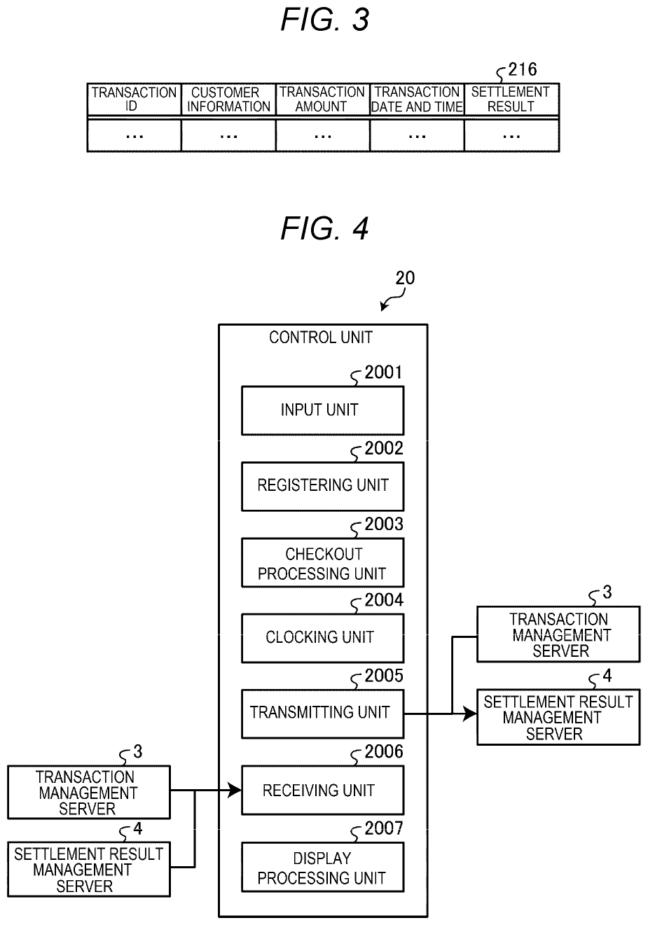

The cashless settlement management file 216 is a file for managing information concerning transactions relating to cashless settlement among transactions for which checkout processing is performed by the POS terminal 2. FIG. 3 is a diagram illustrating a data configuration of the cashless settlement management file 216. In data registered in the cashless settlement management file 216, kinds of information relating to a transaction ID, customer information, a transaction amount, a transaction date and time, and a settlement result are associated. The cashless settlement management file 216 may also manage information concerning a transaction relating to cash settlement for which checkout processing is performed by the POS terminal 2.

In an item of the transaction ID, a transaction ID for identifying a transaction between the store S and a customer is registered. The transaction ID is, for example, information including the store ID 214 for identifying the store and the terminal ID 215 for identifying a terminal in which the transaction is executed. The transaction ID is issued if checkout processing is executed by the POS terminal 2. The transaction ID is an example of transaction specifying information.

In an item of the customer information, information concerning the customer necessary for cashless settlement, for example, credit card information read by the card reader 25 or the scanner 24 is registered. In an item of the customer information, a mail address of the user terminal 6 is registered. As the mail address of the user terminal 6, a mail address corresponding to a member ID read by the card reader 25 or the like in the transaction is read out from the member master 213 and registered.

In an item of the transaction amount, information indicating an amount of the transaction is registered.

In an item of the transaction date and time, information indicating a date and time when settlement is received, for example, a date and time when the customer information necessary for the cashless settlement is read is registered. In the item of the transaction date and time, information indicating a date and time when the settlement is completed may be registered.

In an item of the settlement result, result information is registered. The result information is information indicating a result of the server 5 processing the transaction, for example, information indicating settlement completion or information indicating that settlement is not successfully performed.

Referring back to FIG. 2, a hardware configuration of the POS terminal 2 is explained.

The display 22 is configured by, for example, a liquid crystal panel and functions as a display unit that displays various kinds of information. The display 22 displays, for example, commodity information of a registered commodity and an operation element to be operated by an operator. The display 22 displays information based on result information received from the transaction management server 3 or the settlement result management server 4. The information based on the result information may be the result information itself, may be information indicating, for example, settlement is completed or the settlement is not successfully performed because of, for example, expiration of a credit card, or may be information for guiding the operator in operation that the operator should perform next according to the result information. The display 22 is an example of a display device.

The touch panel 23 is provided on the surface of the display 22 and used to input information corresponding to a touched position to the control unit 20 of the POS terminal 2. The touch panel 23 functions as an operation input unit. The touch panel 23 is used for, for example, an input of a commodity code and an instruction input for cashless settlement. A keyboard may be provided in addition to or instead of the touch panel 23 as the operation input unit.

The scanner 24 reads a commodity code from a code symbol attached to a commodity. The scanner 24 reads customer information necessary for two-dimensional code settlement and electronic money settlement from the user terminal 6 of the customer. The scanner 24 may be a scanner stationarily provided in a main body unit of the POS terminal 2 or a handy scanner detachably provided in the main body unit of the POS terminal 2.

The card reader 25 reads a member code from a medium such as a member card or a point card of the customer. The card reader 25 reads customer information necessary for credit card settlement from a credit card of the customer. The card reader 25 may be a magnetic card reader that reads information from a magnetic card or may be an IC card reader that reads information from a card incorporating an IC chip.

The printer 26 dispenses a receipt on which information relating to a transaction is printed. A commodity name and a unit price of a transacted commodity, a total amount of the transaction, and the like are printed on the receipt.

The timepiece unit 27 is a clocking device such as an RTC (Real Time Clock) and clocks the present time.

The communication unit 28 is an interface for communicating with external devices such as the transaction management server 3 and the settlement result management server 4. The control unit 20 is capable of transmitting and receiving information (data) to and from the external devices by being connected to the external devices via the communication unit 28.

Subsequently, a functional configuration of the control unit 20 of the POS terminal 2 is explained. FIG. 4 is a block diagram illustrating a main functional configuration of the control unit 20 of the POS terminal 2. The CPU 201 operates according to a control program stored in the ROM 202 or the memory unit 21, whereby the control unit 20 functions as an input unit 2001, a registering unit 2002, a checkout processing unit 2003, a clocking unit 2004, a transmitting unit 2005, a receiving unit 2006, and a display processing unit 2007. These functions may be configured by hardware such as dedicated circuits. In FIG. 4, for convenience, two transaction management servers 3 are illustrated. However, the transaction management servers 3 indicate the same transaction management server 3. Similarly, two settlement result management servers 4 are illustrated. However, the settlement result management servers 4 indicate the same settlement result management server 4.

Various kinds of information such as information read by the scanner 24 or the card reader 25 and information input to the touch panel 23 are input to the input unit 2001. For example, a commodity code read by the scanner 24, credit card information read by the card reader 25, various kinds of instruction information input to the touch panel 23 are input to the input unit 2001.

The registering unit 2002 performs commodity registration based on a commodity code input to the input unit 2001. Specifically, the registering unit 2002 reads out, from the commodity master 212, commodity information (a commodity name, a price, and the like) corresponding to the commodity code input to the input unit 2001 and stores the commodity code and the commodity information in the RAM 203. The commodity registration means storing (registering) commodity information of a commodity identified by the commodity code input to the input unit 2001.

The checkout processing unit 2003 executes checkout processing relating to one transaction. As the checkout processing, the checkout processing unit 2003 executes calculation of a total amount of the one transaction, calculation of a change amount in cash settlement, acquisition of customer information in cashless settlement, printing of a receipt after settlement completion, and the like.

The clocking unit 2004 clocks a time based on an output of the timepiece unit 27. For example, the clocking unit 2004 clocks a predetermined time after the transmitting unit 2005 transmits a settlement request explained below to the transaction management server 3. The predetermined time is, for example, a time from when the POS terminal 2 transmits the settlement request until when the POS terminal 2 receives a settlement result notification in a flow of cashless settlement and is also a time for the POS terminal 2 to determine that a communication error occurs.

The transmitting unit 2005 transmits various kinds of information to the transaction management server 3 and the settlement result management server 4. For example, the transmitting unit 2005 transmits a settlement request to the transaction management server 3. The settlement request is a request for requesting the settlement server 5 to perform cashless settlement processing concerning a transaction. In this embodiment, the settlement request is transmitted to the settlement server 5 via the transaction management server 3. The settlement request transmitted by the transmitting unit 2005 includes settlement information such as a transaction ID, a store ID, a terminal ID, customer information, a transaction amount, and a transaction date and time. The settlement server 5 executes settlement processing in response to the settlement request transmitted from the transmitting unit 2005. The transmitting unit 2005 transmits request information to the settlement result management server 4. The request information is information indicating that the settlement request is transmitted from the POS terminal 2 to the settlement server 5 and includes the transaction ID, the store ID, the terminal ID, and the customer information. The settlement result management server 4 registers, based on the request information transmitted from the transmitting unit 2005, information concerning the transaction for which the settlement request is transmitted.

Further, if the receiving unit 2006 does not receive result information for the settlement request from the transaction management server 3 even if a predetermined time elapses after the settlement request is output, the transmitting unit 2005 transmits a settlement result request to the settlement result management server 4. The settlement result request is a request for requesting a settlement result of the transaction by the settlement server 5 and includes the transaction ID and the terminal ID. If the receiving unit 2006 receives a settlement result notification from the transaction management server 3 as explained below, the transmitting unit 2005 may transmit, to the settlement result management server 4, acquisition finish information indicating that the settlement result notification is acquired.

The receiving unit 2006 receives various kinds of information from the transaction management server 3 and the settlement result management server 4. For example, the receiving unit 2006 receives the settlement result notification from the transaction management server 3. The settlement result notification indicates a processing result of the settlement server 5 and is an example of result information. The receiving unit 2006 can also be considered receiving the settlement result notification from the settlement server 5 via the transaction management server 3. The receiving unit 2006 receives, from the settlement result management server 4, the settlement result notification for the settlement result request transmitted to the settlement result management server 4 by the transmitting unit 2005.

The display processing unit 2007 causes the display 22 to display information based on the settlement result notification received from the settlement result management server 4. The display processing unit 2007 causes the display 22 to display other various kinds of information. For example, the display processing unit 2007 causes the display 22 to display, for example, information concerning a commodity registered by the registering unit 2002.

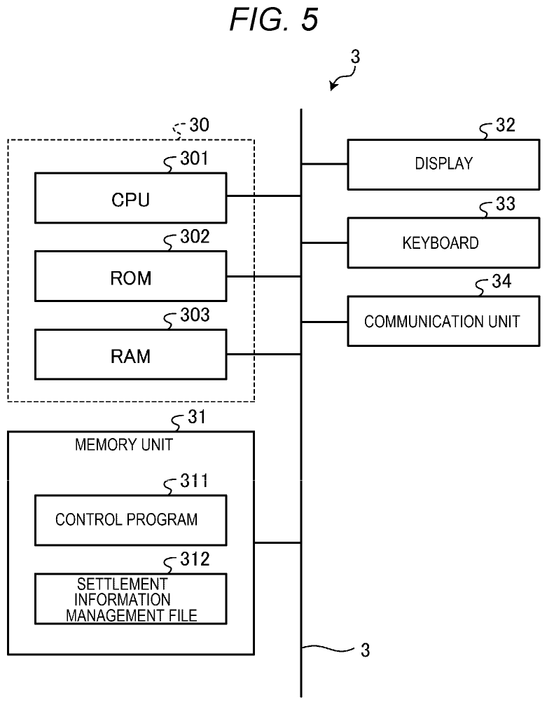

The transaction management server 3 is explained, for example in FIG. 5. FIG. 5 is a block diagram illustrating a main hardware configuration of the transaction management server 3. The transaction management server 3 includes a control unit 30, a memory unit 31, a display 32, a keyboard 33, and a communication unit 34. The control unit 30, the memory unit 31, the display 32, the keyboard 33, and the communication unit 34 are connected to one another via a bus 35 or the like.

The control unit 30 is configured by a computer including a CPU 301, a ROM 302, and a RAM 303. The CPU 301, the ROM 302, and the RAM 303 are connected to one another via the bus 35.

The CPU 301 controls the operation of the entire transaction management server 3. The ROM 302 stores various programs such as a program used for driving of the CPU 301 and various data. The RAM 303 is used as a work area of the CPU 301. Various programs and various data stored in the ROM 302 and the memory unit 31 are loaded in the RAM 303. The CPU 301 operates according to a control program stored in the ROM 302 or the memory unit 31 and loaded in the RAM 303, whereby the control unit 30 executes various kinds of control processing of the transaction management server 3.

The memory unit 31 is configured by a storage medium such as a HDD or a flash memory and maintains stored content even if the transaction management server 3 is turned off. The memory unit 31 stores a control program 311 and a settlement information management file 312.

The control program 311 is, for example, a program for managing, based on settlement requests received from the POS terminals 2 and settlement result notifications received from the settlement servers 5, information concerning transactions relating to cashless settlement among transactions in the stores S.

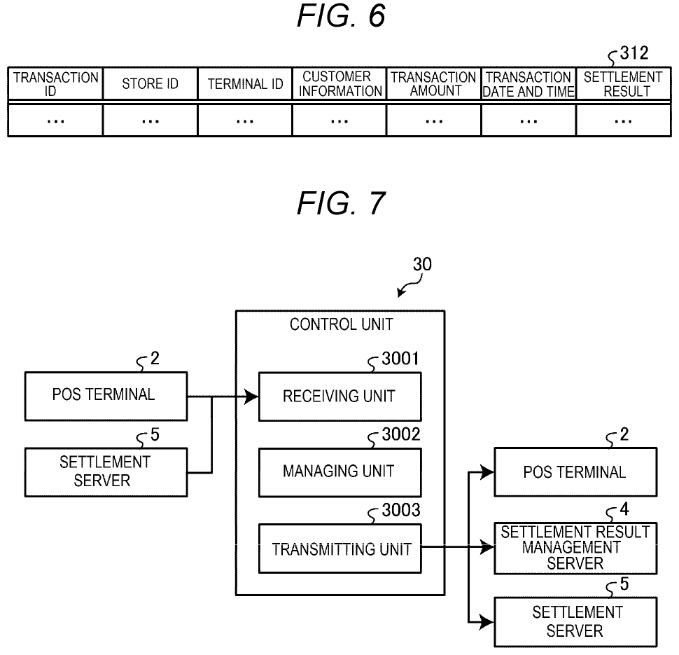

The settlement information management file 312 is a file for managing settlement information of transactions relating to the settlement requests received from the POS terminals 2. FIG. 6 is a diagram illustrating a data configuration of the settlement information management file 312. In data registered in the settlement information management file 312, kinds of information indicating a transaction ID, a store ID, a terminal ID, customer information, a transaction amount, a transaction date and time, and a settlement result are associated.

Information registered in items of the transaction ID, the store ID, the terminal ID, the customer information, the transaction amount, and the transaction date and time is information included in a settlement request received from the POS terminal 2 and is registered based on the settlement request. Information registered in an item of the settlement result is registered based on a settlement result notification received from the settlement server 5. Since contents of these kinds of information are explained in the explanation of the POS terminal 2. Therefore, redundant explanation of the contents is omitted.

Referring back to FIG. 5, a hardware configuration of the transaction management server 3 is explained.

The display 32 is configured by, for example, a liquid crystal panel and functions as a display unit that displays various kinds of information. The display 32 displays, for example, information stored in the settlement information management file 312.

The keyboard 33 functions as an operation input unit for inputting information to the control unit 30. As the operation input unit, a touch panel provided on the surface of the display 32, a mouse, or the like may be used.

The communication unit 34 is an interface for communicating with external devices such as the POS terminals 2, the settlement result management server 4, and the settlement server 5. The control unit 30 is capable of transmitting and receiving information (data) to and from the external devices by being connected to the external devices via the communication unit 34.

Subsequently, a functional configuration of the control unit 30 of the transaction management server 3 is explained. FIG. 7 is a block diagram illustrating a main functional configuration of the control unit 30 of the transaction management server 3. The CPU 301 operates according to a control program stored in the ROM 302 or the memory unit 31, whereby the control unit 30 functions as a receiving unit 3001, a managing unit 3002, and a transmitting unit 3003. These functions may be configured by hardware such as a dedicated circuit. In FIG. 7, for convenience, two POS terminals 2 are illustrated. However, the POS terminals 2 indicate the same POS terminal 2. Similarly, two settlement servers 5 are illustrated. However, the settlement servers 5 indicate the same settlement server 5.

The receiving unit 3001 receives a settlement request concerning a transaction from the POS terminal 2. The receiving unit 3001 receives, from the settlement server 5, a settlement result notification indicating a result of the settlement server 5 processing the transaction.

The managing unit 3002 manages the transaction relating to the settlement request received by the receiving unit 3001. Specifically, the managing unit 3002 registers, in the settlement information management file 312, settlement information included in the settlement request received from the POS terminal 2 by the receiving unit 3001. Specifically, the managing unit 3002 registers, in the settlement information management file 312, kinds of information indicating a transaction ID, a store ID, a terminal ID, customer information, a transaction amount, a transaction date and time, and a settlement result, which are settlement information.

The managing unit 3002 updates the settlement information management file 312 based on a settlement result notification received from the settlement server 5 by the receiving unit 3001. Specifically, the managing unit 3002 registers, in an item of the settlement result of the settlement information management file 312, a processing result of the settlement server 5 indicated by the settlement result notification. In other words, information registered in the item of the settlement result of the settlement information management file 312 can also be considered an example of result information.

The transmitting unit 3003 transmits a settlement request to the settlement server 5. Specifically, the transmitting unit 3003 specifies a settlement company according to customer information, for example, credit card information included in the settlement request received from the POS terminal 2 by the receiving unit 3001 and transmits a settlement request to the settlement server 5 of the specified settlement company.

The transmitting unit 3003 transmits a settlement result notification to the POS terminal 2. Specifically, if the receiving unit 3001 receives a settlement result notification including a transaction ID from the settlement server 5, the transmitting unit 3003 specifies a terminal ID corresponding to the transaction ID referring to the settlement information management file 312 and transmits the settlement result notification to the POS terminal 2 specified by the terminal ID. Further, the transmitting unit 3003 transmits the settlement result notification to the settlement result management server 4.

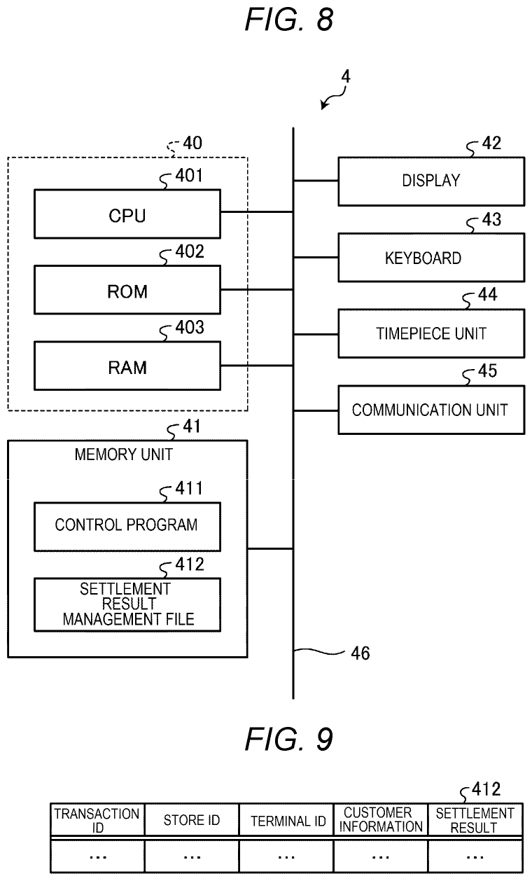

The settlement result management server 4 is explained. FIG. 8 is a block diagram illustrating a main hardware configuration of the settlement result management server 4. The settlement result management server 4 includes a control unit (controller) 40, a memory unit 41, a display 42, a keyboard 43, a timepiece unit 44, and a communication unit 45. The control unit 40, the memory unit 41, the display 42, the keyboard 43, the timepiece unit 44, and the communication unit 45 are connected to one another via a bus 46 or the like.

The control unit 40 is configured by a computer including a CPU 401, a ROM 402, and a RAM 403. The CPU 401, the ROM 402, and the RAM 403 are connected to one another via the bus 46.

The CPU 401 controls the operation of the entire settlement result management server 4. The ROM 402 stores various programs such as a program used for driving of the CPU 401 and various data. The RAM 403 is used as a work area of the CPU 401. Various programs and various data stored in the ROM 402 and the memory unit 41 are loaded in the RAM 403. The CPU 401 operates according to a control program stored in the ROM 402 or the memory unit 41 and loaded in the RAM 403, whereby the control unit 40 executes various kinds of control processing of the settlement result management server 4.

The memory unit 41 is configured by a storage medium such as a HDD or a flash memory and maintains stored content even if the settlement result management server 4 is turned off. The memory unit 41 stores a control program 411 and a settlement result management file 412.

The control program 411 is, for example, a program for managing, based on request information received from the POS terminals 2 and a settlement result notification received from the transaction management server 3, a result of a transaction relating to cashless settlement.

The settlement result management file 412 is a file for managing settlement results of transactions relating to settlement requests received from the POS terminals 2. The settlement result management file 412 is an example of settlement result management information. FIG. 9 is a diagram illustrating a data configuration of the settlement result management file 412. In data registered in the settlement result management file 412, kinds of information indicating a transaction ID, a store ID, a terminal ID, customer information, and a settlement result are associated.

Information registered in items of the transaction ID, the store ID, the terminal ID, and the customer information is information included in request information received from the POS terminal 2 and is registered based on the request information. Information registered in an item of the settlement result is registered based on a settlement result notification received from the settlement server 5 via the transaction management server 3. Contents of these kinds of information are explained above. Therefore, redundant explanation of the contents is omitted.

Referring back to FIG. 8, a hardware configuration of the settlement result management server 4 is explained.

The display 42 is configured by, for example, a liquid crystal panel and functions as a display unit that displays various kinds of information. The display 42 displays, for example, information stored in the settlement result management file 412.

The keyboard 43 functions as an operation input unit for inputting information to the control unit 40. As the operation input unit, a touch panel provided on the surface of the display 42, a mouse, or the like may be used.

The timepiece unit 44 is a clocking device such as an RTC and clocks the present time.

The communication unit 45 is an interface for communicating with external devices such as the POS terminals 2, the transaction management server 3, and the user terminal 6. The control unit 40 is capable of transmitting and receiving information (data) to and from the external devices by being connected to the external devices via the communication unit 45.

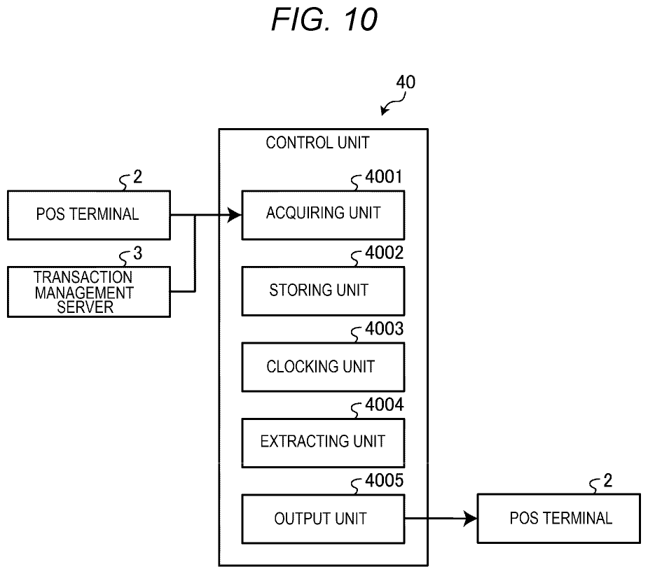

Subsequently, a functional configuration of the control unit 40 of the settlement result management server 4 is explained. FIG. 10 is a block diagram illustrating a main functional configuration of the control unit 40 of the settlement result management server 4. The CPU 401, which may have one or more processors, operates according to a control program stored in the ROM 402 or the memory unit 41, whereby the control unit 40 functions as an acquiring unit 4001, a storing unit 4002, a clocking unit 4003, an extracting unit 4004, and an output unit 4005. These functions may be configured by hardware such as a dedicated circuit. In FIG. 10, for convenience, two POS terminals 2 are illustrated. However, the POS terminals 2 indicate the same POS terminal 2.

The acquiring unit 4001 acquires transaction specifying information for specifying a transaction for which a settlement request is output from the POS terminal 2. Specifically, the acquiring unit 4001 acquires request information including a transaction ID from the POS terminal 2. The acquiring unit 4001 is an example of a specifying-information acquiring unit.

The acquiring unit 4001 acquires result information indicating a result of the settlement server 5 processing, in response to the settlement request, the transaction specified by the transaction specifying information. Specifically, the acquiring unit 4001 acquires, from the settlement server 5, via the transaction management server 3, a settlement result notification indicating a result of the settlement server 5 performing settlement processing of a transaction specified by the transaction ID. The acquiring unit 4001 is an example of a result-information acquiring unit as well. The acquiring unit 4001 may directly acquire a settlement result notification from the settlement server 5 not via the transaction management server 3.

Further, the acquiring unit 4001 acquires, from the POS terminal 2 that outputs a settlement request for a transaction, acquisition finish information indicating that result information relating to the transaction is acquired. Specifically, the acquiring unit 4001 acquires, from the POS terminal 2, acquisition finish information indicating that the POS terminal 2 acquires a settlement result notification from the transaction management server 3. The acquiring unit 4001 is an example of an acquisition-finish-information acquiring unit as well.

The storing unit 4002 stores settlement result management information in which the transaction specifying information acquired by the specifying-information acquiring unit and the result information acquired by the result-information acquiring unit are associated. Specifically, the storing unit 4002 registers the transaction ID acquired by the acquiring unit 4001 and the settlement result indicated by the settlement result notification acquired by the acquiring unit 4001 in the settlement result management file 412 in association with each other.

The clocking unit 4003 clocks a time based on an output of the timepiece unit 27. For example, the clocking unit 4003 clocks a predetermined time after the acquiring unit 4001 acquires the request information including the transaction ID from the POS terminal 2. The predetermined time can be optionally set.

When receiving a settlement result request including the transaction specifying information from the POS terminal 2, the extracting unit 4004 extracts result information corresponding to the transaction specifying information from the settlement result management information. Specifically, if receiving a settlement result request including the transaction ID from the POS terminal 2, the extracting unit 4004 reads out result information registered in the item of the settlement result corresponding to the transaction ID referring to the settlement result management file 412.

After the acquiring unit 4001 acquires request information including the transaction ID from the POS terminal 2, if a predetermined time elapses, the extracting unit 4004 reads out result information registered in the item of the settlement result corresponding to the transaction ID.

If a predetermined time elapses after the specifying-information acquiring unit acquires the transaction specifying information, the output unit 4005 outputs the result information acquired by the result-information acquiring unit to the POS terminal 2 that outputs the settlement request for the transaction specified by the transaction specifying information. Specifically, the output unit 4005 transmits, to the POS terminal 2, as a settlement result notification, result information read out by the extracting unit 4004 if a predetermined time elapses after the acquiring unit 4001 acquires the request information including the transaction ID from the POS terminal 2.

The output unit 4005 may output the result information on condition that the acquisition-finish-information acquiring unit does not acquire the acquisition finish information before the predetermined time elapses after the specifying-information acquiring unit acquires the transaction specifying information. Specifically, if the acquiring unit 4001 acquires the acquisition finish information indicating that the settlement result notification is already acquired from the POS terminal 2 before the predetermined time elapses after acquiring the request information including the transaction ID, the output unit 4005 does not output the settlement result notification to the POS terminal 2.

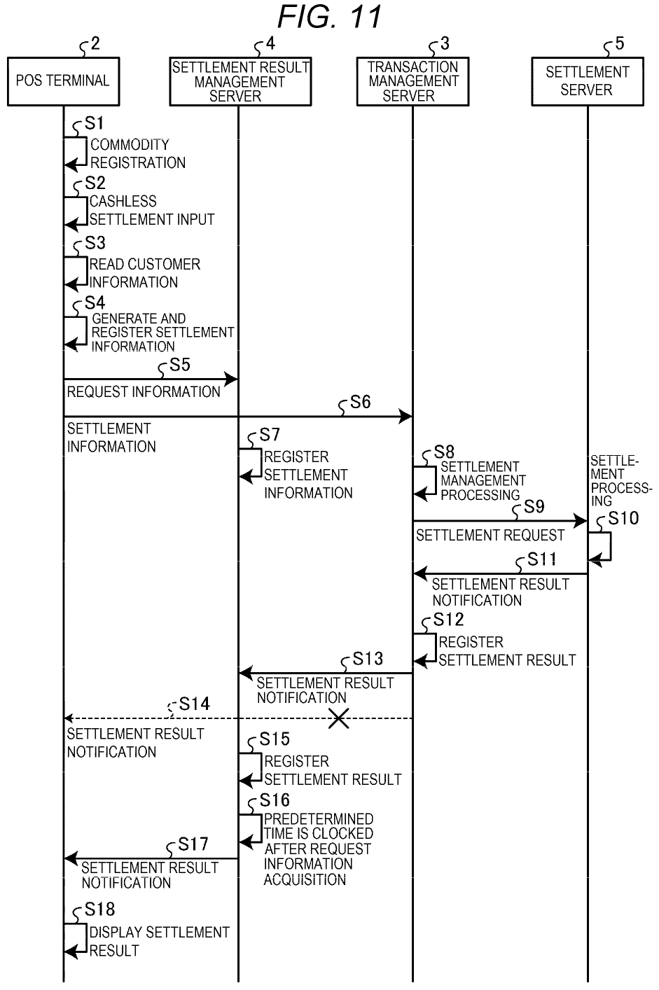

An overview of the operation of the settlement result notification system 1 having the configuration explained above is explained. FIG. 11 is a sequence chart illustrating a flow of the operation of the settlement result notification system 1. The sequence chart illustrates, as an example of the operation of the settlement result notification system 1, an operation performed if the POS terminal 2 does not successfully receive a settlement result notification transmitted from the transaction management server 3.

If a transaction is performed in the store S, commodity registration is performed by the POS terminal 2 for a commodity purchased by a customer (Act 1). If the customer desires cashless settlement, an instruction to make payment by cashless settlement is input to the POS terminal 2 (Act 2).

Subsequently, the POS terminal 2 reads a member code from a member card and, for example, reads credit information from a credit card with the card reader 25. Consequently, customer information is read (Act 3). The POS terminal 2 issues a transaction ID, generates settlement information in which a store ID, a terminal ID, customer information, a transaction amount, and a transaction date and time are associated with the issued transaction ID and registers necessary information in the cashless settlement management file 216 (Act 4).

Subsequently, the POS terminal 2 transmits, to the settlement result management server 4, request information including information indicating that a settlement request is to be output (or is output) and the generated settlement information (Act 5) and transmits a settlement request including the settlement information to the transaction management server 3 (Act 6).

The settlement result management server 4 registers necessary information among the settlement information included in the received request information in the settlement result management file 412 (Act 7).

When receiving the settlement request from the POS terminal 2, the transaction management server 3 executes settlement management processing (Act 8). The settlement management processing is processing for registering the settlement information included in the received settlement request in the settlement information management file 312 and processing for selecting, based on the customer information included in the settlement information, the settlement server 5 to which the settlement request is transmitted. The processing for selecting the settlement server 5 is processing for selecting the settlement server 5 of a settlement company of the cashless settlement desired by the customer. The transaction management server 3 transmits the settlement request to the settlement server 5 selected by the settlement management processing (Act 9).

The settlement server 5 executes settlement processing in response to the received settlement request (Act 10). The settlement processing is processing performed by a settlement company for the customer to make payment and includes authorization processing for checking a use limit amount and an expiration date in the case of credit cart settlement. If the settlement processing is completed, the settlement server 5 transmits a settlement result notification including the transaction ID to the transaction management server 3 (Act 11).

The transaction management server 3 registers a settlement result indicated by the received settlement result notification in the settlement information management file 312 (Act 12). The transaction management server 3 transmits the settlement result notification to the settlement result management server 4 (Act 13) and transmits the settlement result notification to the POS terminal 2 as well (Act 14).

The settlement result management server 4 registers information indicated by the received settlement result notification in the settlement result management file 412 (Act 15). The settlement result management server 4 may receive the settlement result notification from the settlement server 5. If a predetermined time is clocked after the request information is acquired in Act 5 (Act 16), the settlement result management server 4 transmits the settlement result notification to the POS terminal 2 (Act 17).

At this time, the settlement result management server 4 can transmit the settlement result notification to the user terminal 6 as well. Since the settlement result notification is transmitted to the user terminal 6 as well, correct settlement is promoted. This is because, if a settlement terminal is a terminal with which operation concerning payment is performed by a customer such as a self-service POS terminal, for example, even if, despite the fact that a processing result of the settlement server 5 is settlement failure, the customer moves away from the POS terminal 2 without noticing the settlement failure, it is possible to inform the settlement failure to the customer and urge the user to make payment again.

For example, even if the settlement result notification that should be transmitted in Act 14 is not transmitted because of a deficiency of the settlement management server 3 or if the POS terminal 2 cannot receive the settlement result notification because of, for example, a communication failure between the transaction management server 3 and the POS terminal 2, the POS terminal 2 can acquire the settlement result notification through the processing in Act 17. Accordingly, it is possible to prevent an error from occurring because the POS terminal 2 cannot receive the settlement result notification. Therefore, it is possible to reduce operation of a customer and jobs of a store clerk performed according to error processing. For example, the customer less frequently calls the store clerk and the store clerk less frequently confirms a settlement result with a settlement company.

If the settlement result management server 4 directly acquires the settlement result notification from the settlement server 5, even if a communication failure occurs between the settlement server 5 and the transaction management server 3, the POS terminal 2 can acquire the settlement result notification.

If the POS terminal 2 receives the settlement result notification transmitted by the transaction management server 3 in Act 14, in other words, if the POS terminal 2 receives the settlement result notification before a predetermined time elapses after the POS terminal 2 outputs the settlement request, the POS terminal 2 may transmit, to the settlement result management server 4, acquisition finish information indicating that the settlement result notification is already acquired. In this case, the settlement result management server 4 transmits the settlement result notification to the POS terminal 2 on condition that the acquisition finish information is not received within a predetermined time after the request information is acquired.

The POS terminal 2 displays, on the display 22, the settlement result indicated by the settlement result notification received from the settlement result management server 4 (Act 18). If receiving the settlement result notification in Act 14, the POS terminal 2 displays the settlement result indicated by the settlement result notification on the display 22.

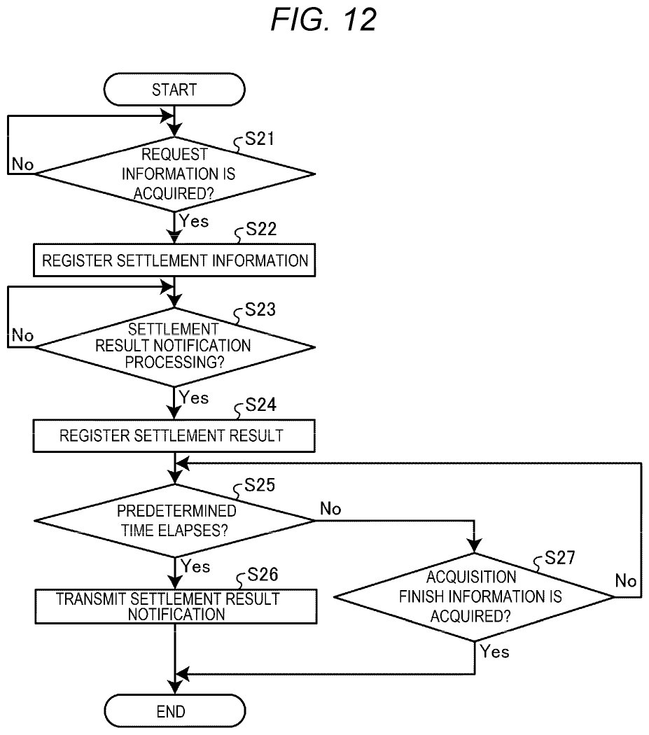

Settlement result notification processing executed by the settlement result management server 4 is explained, for example with respect to FIG. 12. FIG. 12 is a flowchart illustrating a flow of the settlement result notification processing in the control unit 40 of the settlement result management server 4.

The control unit 40 determines whether the acquiring unit 4001 acquires request information from the POS terminal 2 (Act 21) and, if the acquiring unit 4001 does not acquire the request information (N in Act 21), returns to the processing in Act 21 and stays on standby. If the acquiring unit 4001 acquires the request information (Y in Act 21), the storing unit 4002 extracts necessary information from settlement information included in the request information and registers the necessary information in the settlement result management file 412 (Act 22).

Subsequently, the control unit 40 determines whether the acquiring unit 4001 acquires a settlement result notification from the settlement management server 3 for a transaction relating to the request information acquired by the acquiring unit 4001 (Act 23) and, if the acquiring unit 4001 does not acquire the settlement result notification (N in Act 23), returns to Act 23 and stays on standby. If the acquiring unit 4001 acquires the settlement result notification (Y in Act 23), the storing unit 4002 registers information indicated by the settlement result notification in the settlement result management file 412 (Act 24).

Subsequently, the control unit 40 determines whether a predetermined time is clocked by the clocking unit 4003, that is, whether the predetermined time elapses after the acquiring unit 4001 acquires the request information (Act 25). When the predetermined time elapses (Y in Act 25), the output unit 4005 transmits the settlement result notification to the POS terminal 2 (Act 26). The control unit 40 ends the settlement result notification processing.

If the predetermined time does not elapse in the processing in Act 25 (N in Act 25), the control unit 40 determines whether the acquiring unit 4001 acquires acquisition finish information from the POS terminal 2 (Act 27). If the acquiring unit 4001 does not acquire the acquisition finish information (N in Act 27), the control unit 40 returns to the processing in Act 25. If the acquiring unit 4001 acquires the acquisition finish information (Y in Act 27), the control unit 40 ends the settlement result notification processing.

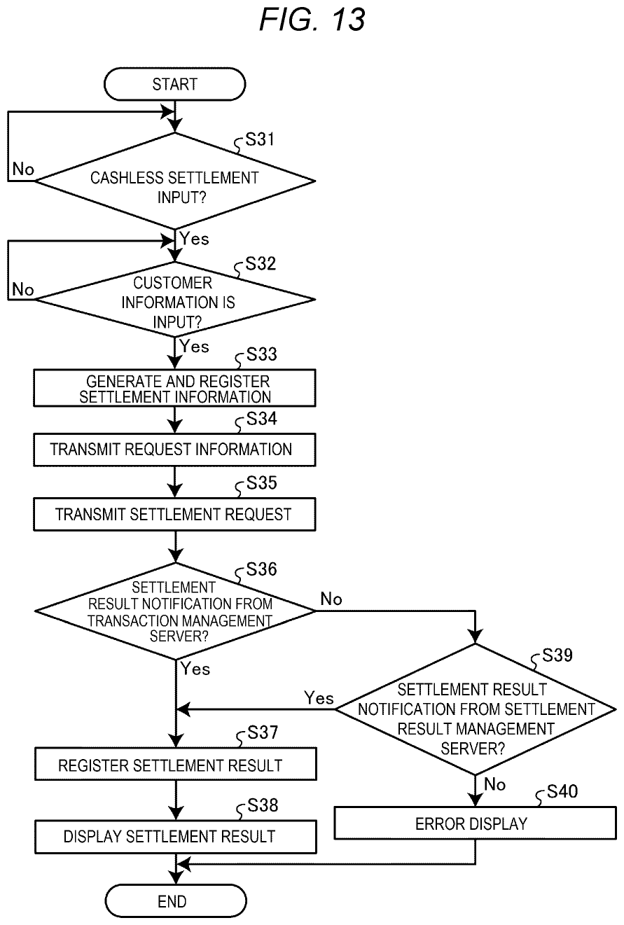

Cashless settlement processing executed by the POS terminal 2 is explained, for example with respect to FIG. 13. FIG. 13 is a flowchart illustrating a flow of the cashless settlement processing in the control unit 20 of the POS terminal 2. The cashless settlement processing is executed as a part of checkout processing executed by the checkout processing unit 2003 based on commodity registration performed by the registering unit 2002.

The control unit 20 determines whether an instruction for cashless settlement is input to the input unit 2001 (Act 31) and, if the instruction is not input (N in Act 31), returns to the processing in Act 31 and stays on standby. If the instruction for cashless settlement is input to the input unit 2001 (Y in Act 31), the control unit 20 determines whether customer information is input to the input unit 2001 (Act 32) and, if customer information is not input (N in Act 32), returns to the processing in Act 32 and stays on standby.

If customer information is input to the input unit 2001 (Y in Act 32), the control unit 20 issues a transaction ID, generates settlement information in which a store ID, a terminal ID, customer information, a transaction amount, and a transaction date and time are associated with the issued transaction ID and registers necessary information in the cashless settlement management file 216 (Act 33).

Subsequently, the transmitting unit 2005 transmits request information to the settlement result management server 4 (Act 34) and transmits a settlement request to the transaction management server 3 (Act 35).

Subsequently, the control unit 20 determines whether the receiving unit 2006 receives a settlement result notification from the transaction management server 3 (Act 36) and, if the receiving unit 2006 receives the settlement result notification (Y in Act 36), registers a settlement result indicated by the settlement result notification in the cashless settlement management file 216 (Act 37). The display processing unit 2007 displays the settlement result on the display 22 (Act 38). The control unit 20 ends the cashless settlement processing.

If the receiving unit 2006 does not receive the settlement result notification from the transaction management server 3 in the processing in Act 36 (N in Act 36), the control unit 20 determines whether the receiving unit 2006 receives the settlement result notification from the settlement result management server 4 within a predetermined time after the transmitting unit 2005 transmits the settlement request to the transaction management server 3 (Act 39). If the receiving unit 2006 receives the settlement result notification from the settlement result management server 4 (Y in Act 39), the control unit 20 shifts to the processing in Act 37.

If the receiving unit 2006 does not receive the settlement result notification from the settlement result management server 4 in the processing in Act 39 (N in Act 39), the display processing unit 2007 performs error display on the display 22. The error display is, for example, display for urging a customer to call a store clerk. If the store clerk confirms the error display, the store clerk contacts a settlement company and performs, for example, confirmation of the settlement result. If finishing the processing in Act 40, the control unit 20 ends the cashless settlement processing.

The customer can perform cashless payment through the cashless settlement processing of the POS terminal 2 explained above. Even in an abnormal situation due to a deficiency or the like of the transaction management server 3, the POS terminal 2 can receive the settlement result notification through the settlement result notification processing of the settlement result management server 4 explained above.

(Modification)

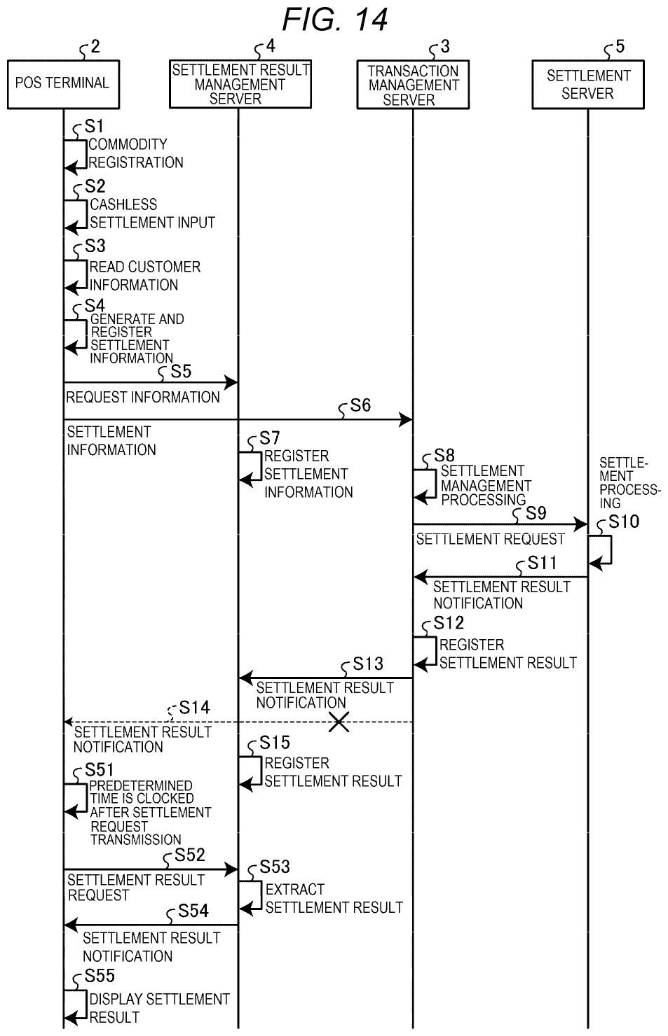

A modification of the settlement result notification system 1 is explained. The modification explained below is different from the example explained above in that the settlement result management server 4 transmits a settlement result notification in response to a settlement result request from the POS terminal 2. FIG. 14 is a sequence chart illustrating a flow of an operation in the modification in the settlement result notification system 1. The same processing as the processing illustrated in FIG. 11 is denoted by the same sign and explanation of the processing is omitted. This is to avoid unnecessary redundancy of the following explanation and facilitate understanding of those skilled in the art.

Processing in Act 1 to Act 15 is the same as the processing illustrated in FIG. 11. If a predetermine time is clocked after the settlement request is transmitted to the transaction management server 3 (Act 51), the POS terminal 2 transmits a settlement result request to the settlement result management server 4 (Act 52).

The settlement result management server 4 extracts, from the settlement result management file 412, a settlement result corresponding to a transaction ID included in the received settlement result request (Act 53). The settlement result management server 4 transmits a settlement result notification indicating the extracted settlement result to the POS terminal 2 (Act 54). At this time, the settlement result management server 4 can transmit the settlement result notification to the user terminal 6 as well.

The POS terminal 2 displays, on the display 22, the settlement result indicated by the settlement result notification received from the settlement result management server 4 (Act 55). If the settlement result notification in Act 14 is received, the POS terminal 2 displays the settlement result indicated by the settlement result notification on the display 22.

Consequently, a load of processing is reduced because the settlement result management server 4 only has to transmit the settlement result notification only if the settlement result request is received from the POS terminal 2.

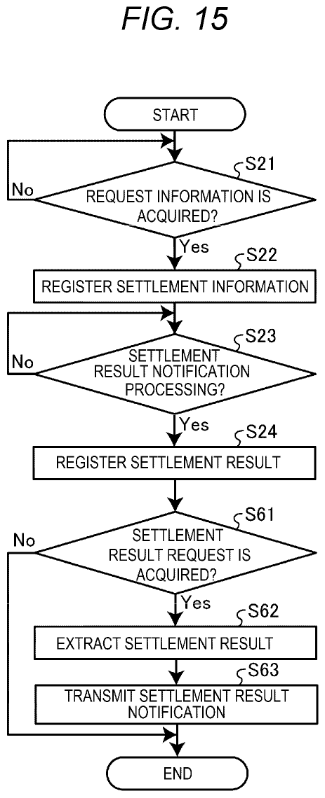

Settlement result notification processing of the settlement result management server 4 in the modification is explained. FIG. 15 is a flowchart illustrating a flow of the settlement result notification processing in the modification by the control unit 40 of the settlement result management server 4. The same processing as the processing illustrated in FIG. 12 is denoted by the same sign and explanation of the processing is omitted.

Processing in Act 21 to Act 24 is the same as the processing illustrated in FIG. 12. Following the processing in Act 24, the control unit 40 determines whether the acquiring unit 4001 acquires a settlement result request from the POS terminal 2 within a predetermined time after the request information is acquired (Act 61) and, if the acquiring unit 4001 does not acquire the settlement result request (N in Act 61), ends the settlement result notification processing.

If the acquiring unit 4001 acquires the settlement result request from the POS terminal 2 (Y in Act 61), the extracting unit 4004 extracts a settlement result (Act 62). The extracting unit 4004 extracts a settlement result corresponding to a transaction ID included in the settlement result request referring to the settlement result management file 412.

The output unit 4005 transmits a settlement result notification indicating the settlement result extracted by the extracting unit 4004 to the POS terminal 2 specified by a terminal ID included in the settlement result request (Act 63). The control unit 40 ends the settlement result notification processing.

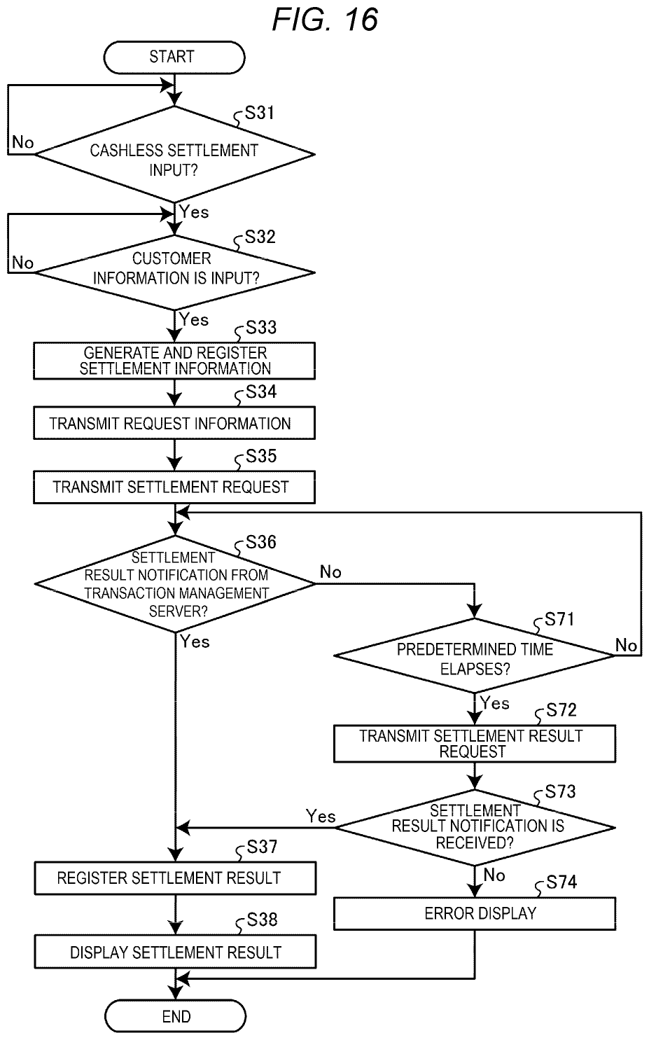

Cashless settlement processing of the POS terminal 2 in the modification is explained. FIG. 16 is a flowchart illustrating a flow of the cashless settlement processing in the modification by the control unit 20 of the POS terminal 2. The same processing as the processing in FIG. 13 is denoted by the same sign and explanation of the processing is omitted.

Processing in Act 31 to Act 38 is the same as the processing illustrated in FIG. 13. If the receiving unit 2006 does not receive the settlement result notification from the transaction management server 3 in the processing in Act 36 (N in Act 36), the control unit 20 determines whether a predetermined time is clocked by the clocking unit 2004, that is, the predetermined time elapses after the transmitting unit 2005 transmits the settlement request (Act 71).

If the predetermined time does not elapse (N in Act 71), the control unit 20 returns to the processing in Act 36. If the predetermined time elapses (Y in Act 71), the transmitting unit 2005 transmits a settlement result request to the settlement result management server 4 (Act 72).

Subsequently, the control unit 20 determines whether the receiving unit 2006 receives a settlement result notification from the settlement result management server 4 (Act 73) and, if the receiving unit 2006 receives the settlement result notification (Y in Act 73), shifts to the processing in Act 37. If the receiving unit 2006 does not receive the settlement result notification from the settlement result management server 4 (N in Act 73), the display processing unit 2007 performs error display on the display 22. The control unit 20 ends the cashless settlement processing.

As explained above, the server device (the settlement result management server 4) in the embodiment includes the specifying-information acquiring unit (the acquiring unit 4001) that acquires transaction specifying information (a transaction ID) for specifying a transaction for which a settlement request is output from the settlement terminal (the POS terminal 2), the result-information acquiring unit (the acquiring unit 4001) that acquires result information (a settlement result notification) indicating a result of the settlement device (the settlement server 5) processing, in response to the settlement request, the transaction specified by the transaction specifying information, and the output unit 4005 that, if a predetermined time elapses after the specifying-information acquiring unit acquires the transaction specifying information, outputs the result information acquired by the result-information acquiring unit to the settlement terminal that outputs the settlement request for the transaction specified by the transaction specifying information.

Consequently, even if, because, for example, a communication failure occurs, the POS terminal 2 cannot receive a settlement result notification that the POS terminal 2 should normally receive, the POS terminal 2 can acquire the settlement result notification from the settlement result management server 4. Accordingly, it is possible to reduce error processing in the POS terminal 2. Therefore, it is possible to reduce labor and time of a customer and jobs of a store clerk that occur because of the error processing.

The settlement result management server 4 further includes the acquisition-finish-information acquiring unit (the acquiring unit 4001) that acquires acquisition finish information indicating that the settlement result notification relating to the transaction is acquired from the POS terminal 2 that outputs the settlement request for the transaction. The output unit 4005 outputs the settlement result notification on condition that the acquisition-finish-information acquiring unit does not acquire the acquisition finish information before a predetermined time elapses after the acquiring unit 4001 acquires the transaction ID.

Consequently, the settlement result management server 4 does not output the settlement result notification if the POS terminal 2 does not need a settlement result. Accordingly, it is possible to reduce a load on the settlement result management server 4.

The server device (the settlement result management server 4) in the embodiment includes the specifying-information acquiring unit (the acquiring unit 4001) that acquires transaction specifying information (a transaction ID) for specifying a transaction for which a settlement request is output from the settlement terminal (the POS terminal 2), the result-information acquiring unit (the acquiring unit 4001) that acquires result information (a settlement result notification) indicating a result of the settlement device (the settlement server 5) processing, in response to the settlement request, the transaction specified by the transaction specifying information, the storing unit 4002 that stores settlement result management information (the settlement result management file 412) in which the transaction specifying information acquired by the specifying-information acquiring unit and the result information acquired by the result-information acquiring unit are associated, the extracting unit 4004 that, if receiving a settlement result request including the transaction specifying information from the settlement terminal, extracts result information corresponding to the transaction specifying information from the settlement result management information, and the output unit 4005 that outputs the result information extracted by the extracting unit 4004 to the settlement terminal that outputs the settlement result request.

Consequently, even if, because, for example, a communication failure occurs, the POS terminal 2 cannot receive a settlement result notification that the POS terminal 2 should normally receive, the POS terminal 2 can acquire the settlement result notification from the settlement result management server 4. Further, the settlement result management server 4 can output the settlement result notification only if the settlement result management server 4 receives the settlement result request from the POS terminal 2, in other words, if the POS terminal 2 needs the settlement result. Therefore, it is possible to reduce a load on the settlement result management server 4.

Moreover, the output unit 4005 of the settlement result management server 4 in the embodiment outputs the settlement result notification to the user terminal 6 carried by a customer who performs the transaction.

Consequently, it is possible to inform the settlement result to the customer even if the customer moves away from the POS terminal 2. The customer can return to the POS terminal 2 and perform necessary operation. Accordingly, correct settlement is promoted.

In the embodiment explained above, the control program executed by the settlement result management server 4, which is the server device, may be provided by being recorded in a computer-readable recording medium such as a CD-ROM. The control program executed by the settlement result management server 4 in the embodiment may be stored on a computer connected to a network such as the Internet and provided by being downloaded through the network. Further, the control program may be provided through a network such as the Internet.

An embodiment is explained above. However, the embodiment is presented as an example and is not intended to limit the scope of the disclosure. The embodiment can be carried out in other various forms. Various omissions, substitutions, and changes can be made without departing from the spirit of the disclosure.

What is claimed is:

1. A server device comprising:
at least one processor configured to:
acquire transaction specifying information for specifying a transaction for which a settlement request is output from a settlement terminal, and
acquire result information indicating a result of a settlement device processing, in response to the settlement request, the transaction specified by the transaction specifying information; and
an output configured to, upon a predetermined time elapsing after the at least one processor acquires the transaction specifying information, output the result information acquired by the at least one processor to the settlement terminal that outputs the settlement request for the transaction specified by the transaction specifying information.

2. The device according to claim 1, wherein the at least one processor is configured to acquire acquisition finish information indicating that the result information relating to the transaction is acquired from the settlement terminal that outputs the settlement request for the transaction, wherein
the output is configured to output the result information on condition that the at least one processor does not acquire the acquisition finish information before the predetermined time elapses after the at least one processor acquires the transaction specifying information.

3. A server device comprising:
at least one processor configured to:
acquire transaction specifying information for specifying a transaction for which a settlement request is output from a settlement terminal, and
acquire result information indicating a result of a settlement device processing, in response to the settlement request, the transaction specified by the transaction specifying information;
a storage configured to store settlement result management information in which the transaction specifying information acquired by the at least one processor and the result information acquired by the at least one processor are associated,
the at least one processor configured to, upon receiving a settlement result request including the transaction specifying information from the settlement terminal, extract the result information corresponding to the transaction specifying information from the settlement result management information; and
an output configured to output the result information extracted by the at least one processor to the settlement terminal that outputs the settlement result request.

4. The device according to claim 1, wherein the output is configured to output the result information to a user terminal carried by a customer who performs the transaction.

5. A settlement result notification system comprising:
a settlement terminal configured to output a settlement request concerning a transaction to a settlement device; and
a server device configured to manage a result of the settlement device processing the transaction in response to the settlement request, wherein
the server device includes:
at least one processor configured to:
acquire transaction specifying information for specifying the transaction for which the settlement request is output from the settlement terminal, and
acquire result information indicating a result of the settlement device processing, in response to the settlement request, the transaction specified by the transaction specifying information; and
an output configured to, upon a predetermined time elapsing after the at least one processor acquires the transaction specifying information, output the result information acquired by the at least one processor to the settlement terminal that outputs the settlement request for the transaction specified by the transaction specifying information, and
wherein the settlement terminal includes a display processor configured to cause a display to display information based on the result information received from the server device.

6. A settlement result notification system comprising:
a settlement terminal configured to output a settlement request concerning a transaction to a settlement device; and
a server device configured to manage a result of the settlement device processing the transaction in response to the settlement request, wherein
the server device includes:
at least one processor configured to:
acquire transaction specifying information for specifying the transaction for which the settlement request is output from the settlement terminal, and
acquire result information indicating a result of the settlement device processing, in response to the settlement request, the transaction specified by the transaction specifying information;
a storage configured to store settlement result management information in which the transaction specifying information acquired by the at least one processor and the result information acquired by the at least one processor are associated;
the at least one processor configured to, upon receiving a settlement result request including the transaction specifying information from the settlement terminal, extract the result information corresponding to the transaction specifying information from the settlement result management information; and
an output configured to output the result information extracted by the at least one processor to the settlement terminal that outputs the settlement result request, and
the settlement terminal includes:
a transmitter configured to, upon the result information for the settlement request not being received from the settlement device even if a predetermined time elapses after the settlement request is output, transmit the settlement result request to the server device; and
a display processor configured to cause a display to display information based on the result information received from the server device.

7. A method for controlling a server device, comprising:
acquiring transaction specifying information for specifying a transaction for which a settlement request is output from a settlement terminal;
acquiring result information indicating a result of a settlement device processing, in response to the settlement request, the transaction specified by the transaction specifying information; and
upon a predetermined time elapsing after the transaction specifying information is acquired, outputting the acquired result information to the settlement terminal that outputs the settlement request for the transaction specified by the transaction specifying information.

8. A method for controlling a server device, comprising:
acquiring transaction specifying information for specifying a transaction for which a settlement request is output from a settlement terminal;
acquiring result information indicating a result of a settlement device processing, in response to the settlement request, the transaction specified by the transaction specifying information;
storing settlement result management information in which the acquired transaction specifying information and the acquired result information are associated;
upon receiving a settlement result request including the transaction specifying information from the settlement terminal, extracting the result information corresponding to the transaction specifying information from the settlement result management information; and
outputting the extracted result information to the settlement terminal that outputs the settlement result request.

9. The device according to claim 1, wherein the settlement request includes a request for cashless settlement processing.

10. The device according to claim 2, wherein the output is configured to output the result information to a user terminal carried by a customer who performs the transaction.

11. The server device according to claim 3, wherein the settlement terminal includes a point of sale terminal.

12. The server device according to claim 11, wherein the settlement terminal includes a self-service point of sale terminal.

13. The server device according to claim 3, wherein the settlement terminal includes a tablet.

14. The settlement result notification system according to claim 5, wherein the settlement terminal includes a point of sale terminal.

15. The settlement result notification system according to claim 6, wherein the output is configured to output the result information to a user terminal carried by a customer who performs the transaction.
